(19) United States
(12) Patent Application Publication
(10) Pub. No.: US 2026/0313218 A1
(43) Pub. Date: Oct. 8, 2026

(54) DISPLAY DEVICE

(71) Applicant: BOE Technology Group Co., Ltd., Beijing (CN)

(72) Inventors: Yan REN, Beijing (CN); Zifeng WANG, Beijing (CN); Yongjie XIANG, Beijing (CN); Zhaowei LI, Beijing (CN); Jian HE, Beijing (CN); Zhaoxi YU, Beijing (CN); Guangning HAO, Beijing (CN); Wei HUANG, Beijing (CN); Zhongcheng LI, Beijing (CN); Xuan ZHAO, Beijing (CN); Xiuhe ZHOU, Beijing (CN); Wenbo DONG, Beijing (CN)

(21) Appl. No.: 18/996,715

(22) PCT Filed: May 31, 2023
(86) PCT No.: PCT/CN2023/097426

§ 371 Date: Jan. 17, 2025

(30) Foreign Application Priority Data
Nov. 30, 2022 (CN) 202211526481.0

(51) Int. Cl. H04N 23/57; H04N 23/51

(52) U.S. Cl. CPC H04N 23/57; H04N 23/51

(57) ABSTRACT

An embodiment of the application provides a display device comprising a frame for carrying an internal module and a camera module comprising a camera and a camera module mounting assembly. The internal module comprises the camera module, the camera module mounting assembly comprises a bracket and a mounting portion, the mounting portion is configured to be detachably connected to the bracket, the bracket and the mounting portion form a first cavity for accommodating the camera when the bracket is connected to the mounting portion, the mounting portion is connected to the frame to assemble the bracket and the camera to the frame. The camera module mounting assembly can be integrated with the camera into the camera module, so that the camera and the camera module mounting assembly are combined into a single module. This helps to realize a smaller overall volume of the camera and the camera module mounting assembly.

### RELATED APPLICATION

The application claims the benefit of Chinese Patent Application No. 202211526481.0 filed on Nov. 30, 2022, the entire disclosure of which is incorporated herein by reference.

### TECHNICAL FIELD

The application pertains to the field of display technologies, in particular to a display device comprising a camera module.

### BACKGROUND

Camera modules for capturing images or videos have been used in a variety of different display devices. By means of internet technology, video interaction and communication between people in different places can be achieved through camera modules. For example, current teaching methods are not limited to knowledge transfer between teachers and students through the blackboard in the classroom. The use of electronic blackboards with camera modules can realize communication and teaching between teachers and students anywhere, breaking a space limitation for traditional teaching. However, there is still room for optimization in the assembly and integration between the camera module and other components of a display device.

### SUMMARY

An embodiment of the application provides a display device. The display device comprises: a frame for carrying an internal module of the display device; and a camera module comprising a camera and a camera module mounting assembly. The internal module comprises the camera module, the camera module mounting assembly comprises a bracket and a mounting portion, the mounting portion is configured to be detachably connected to the bracket, the bracket and the mounting portion form a first cavity for accommodating the camera when the bracket is connected to the mounting portion, the mounting portion is connected to the frame to assemble the bracket and the camera to the frame.

According to some embodiments of the application, the frame comprises a side frame extending along at least a portion of a periphery of the display device.

According to some embodiments of the application, the side frame comprises a first side wall, a second side wall and a third side wall, the first side wall and the second side wall face each other, and the third side wall connects the first side wall and the second side wall respectively to form a second cavity, the first side wall comprises a first opening, the second side wall comprises a second opening, and the camera module mounting assembly passes through the second cavity via the second opening and extends to the first opening, so that an image capturing surface of the camera in the first cavity is exposed via the first opening, the mounting portion is connected to the second side wall of the side frame.

According to some embodiments of the application, the mounting portion comprises a first positioning portion, the bracket comprises a second positioning portion, and the first positioning portion cooperates with the second positioning portion to connect the mounting portion and the bracket.

According to some embodiments of the application, the bracket further comprises a bracket body connected to the second positioning portion, the bracket body comprises a bracket through hole penetrating the bracket body, and the image capturing surface of the camera is exposed via the bracket through hole.

According to some embodiments of the application, one of the first positioning portion and the second positioning portion comprises a buckle, the other of the first positioning portion and the second positioning portion comprises a protrusion matching the buckle, and the buckle mates with the protrusion to connect the mounting portion and the bracket.

According to some embodiments of the application, the second positioning portion comprises a bracket connector extending and protruding from an edge of the bracket body in a direction perpendicular to a plane of the bracket body, the bracket body, the bracket connector and the first positioning portion of the mounting portion form the first cavity when the bracket is connected to the mounting portion via the bracket connector.

According to some embodiments of the application, the camera comprises a back surface facing the image capturing surface and a side surface adjacent to the back surface, the first positioning portion comprises a first support surface for supporting the back surface and a second support surface for supporting a portion of the side surface.

According to some embodiments of the application, the bracket connector of the second positioning portion comprises the buckle, the first positioning portion comprises a first positioning portion body and the protrusion, and the first positioning portion body comprises the first support surface and the second support surface, the protrusion extends and protrudes from a surface of the first positioning portion body facing the second support surface in a direction facing away from the second support surface.

According to some embodiments of the application, the mounting portion further comprises a mounting portion body connected to the first positioning portion, an extension direction of the mounting portion body is consistent with a width direction of the third side wall pointing from the second side wall to the first side wall, and the first support surface forms an included angle of 105 to 115 degrees with respect to the extension direction of the mounting portion body.

According to some embodiments of the application, the display device further comprises a microphone array module and a microphone array mounting assembly for assembling the microphone array module to the side frame, the microphone array mounting assembly is connected to the second side wall, and the microphone array module is disposed between the microphone array mounting assembly and the first side wall.

According to some embodiments of the application, the microphone array module comprises at least one microphone array strip, and the microphone array mounting assembly comprises at least one adapter for connecting respective one of the at least one microphone array strip to the side frame, the adapter comprises at least one presser and at least one hanger, the hanger is connected to a surface of the second side wall facing away from the first side wall, and the presser is connected to a surface of the microphone array strip facing away from the first side wall.

According to some embodiments of the application, the adapter comprises an adapter body, and the at least one presser extends and protrudes from a first edge of the adapter body along a first direction intersecting a plane where the adapter body is located, at least some of the at least one presser comprises a presser body and a presser positioning column, and the presser positioning column extends and protrudes from the presser body in a second direction parallel to the plane where the adapter body is located, the microphone array strip comprises at least one via hole, and the presser positioning column passes through a corresponding via hole of the at least one via hole to position the at least one microphone array strip to the at least one adapter.

According to some embodiments of the application, the display device further comprises a first control board electrically connected to the microphone array module and a support member for supporting the first control board, and the adapter further comprises a bridge structure extending and protruding from the adapter body along a third direction opposite to the first direction, the support member is connected to the bridge structure of the adapter so as to fix the first control board to the side frame via the support member and the adapter.

According to some embodiments of the application, the at least one microphone array strip comprises a first microphone array strip and a second microphone array strip, a length extension direction of each of the first microphone array strip and the second microphone array strip is consistent with a length extension direction of the first side wall of the side frame, and the first microphone array strip and the second microphone array strip are located on two sides of the camera module respectively in the length extension direction of the first side wall.

According to some embodiments of the application, each microphone array strip of the first microphone array strip and the second microphone array strip comprises a plurality of microphones and a plurality of sound receiving holes corresponding to the plurality of microphones, the plurality of sound receiving holes are arranged along a length direction of the microphone array strip, and a distance between any two adjacent sound receiving holes in the first microphone array strip or the second microphone array strip along the length extension direction of the first side wall is equal to a distance between two sound receiving holes of the first microphone array strip and the second microphone array strip which are closest to each other along the length extension direction.

According to some embodiments of the application, the at least one adapter comprises a first adapter and a second adapter for connecting the first microphone array strip and the second microphone array strip to the side frame, respectively, and each hanger in the first adapter and the second adapter extends and protrudes from a second edge of the adapter body facing the first edge along the first direction.

According to some embodiments of the application, the first side wall of the side frame comprises a plurality of grooves in one-to-one correspondence with the plurality of sound receiving holes, each of the grooves is used to accommodate an acoustic foam, the first side wall further comprises a plurality of side wall through holes in one-to-one correspondence with the plurality of grooves, and each side wall through hole extends from a bottom surface of the groove close to an outer surface of the first side wall to the outer surface of the first side wall.

According to some embodiments of the application, the bridge structure extends and protrudes from the second edge of the adapter body along a third direction opposite to the first direction, the support member is connected to bridge structures of the first adapter and the second adapter, respectively, so as to fix the first control board to the side frame via the support member, the first adapter and the second adapter.

According to some embodiments of the application, the display device further comprises a display module and a module backplane for supporting the display module, the support member comprises a support body and a lateral rib, and the lateral rib extends and protrudes from at least a part of an edge of the support body along a fourth direction intersecting a plane of the support body to abut on a surface of the module backplane facing away from the display module.

According to some embodiments of the application, the display device comprises a mainboard for controlling the display device, the camera is electrically connected to the first control board via a camera connection line, and the first control board is electrically connected to the mainboard via a control board connection line, the support body comprises a first notch on a first side of the support body and a second notch on a second side of the support body, the first side and the second side face each other, and the module backplane comprises a backplane opening corresponding to the second notch, the first notch is configured to allow the camera connection line to pass through, and the second notch and the backplane opening are configured to allow the control board connection line to pass through.

According to some embodiments of the application, the camera module mounting assembly further comprises a base connected to the mounting portion, the display device further comprises a second control board electrically connected to the camera, and the second control board and the mounting portion are connected to opposite sides of the base respectively, the bracket is configured to be detachably connected to a side of the mounting portion facing away from the base.

According to some embodiments of the application, one of the first positioning portion and the second positioning portion comprises a positioning hole, and the other of the first positioning portion and the second positioning portion comprises a clamping positioning column, the clamping positioning column extends into the positioning hole to connect the mounting portion and the bracket.

According to some embodiments of the application, the second positioning portion comprises the positioning hole, the first positioning portion comprises the clamping positioning column, the clamping positioning column comprises a first connection section and a first clamping section connected to each other, an end of the first connection section away from the first clamping section is connected to the mounting portion, a side wall of the positioning hole is provided with an engagement groove, the first connection section extends into the positioning hole, and the first clamping section is engaged in the engagement groove.

According to some embodiments of the application, the bracket comprises an accommodating groove, the mounting portion and the accommodating groove form the first cavity when the bracket is connected to the mounting portion, the bracket comprises two positioning holes, and the two positioning holes are arranged on two sides of the accommodating groove respectively.

According to some embodiments of the application, the mounting portion further comprises a first fixing portion, the bracket further comprises a second fixing portion, and the first fixing portion and the second fixing portion cooperate to limit a displacement of the bracket in a predetermined direction, the predetermined direction is different from a connection direction in which the bracket is connected to the mounting portion.

According to some embodiments of the application, one of the first fixing portion and the second fixing portion comprises a fixing hole, and the other of the first fixing portion and the second fixing portion comprises a fixing column, the fixing column extends into the fixing hole to limit a displacement of the bracket in a predetermined direction.

According to some embodiments of the application, the accommodating groove comprises a limiting rib, and the limiting rib is configured to support a side surface of the camera adjacent to the image capturing surface, so that the side surface forms an included angle of 5 to 20 degrees with respect to a horizontal direction perpendicular to the first side wall of the side frame, the first side wall comprises a first opening, and the image capturing surface of the camera is exposed via the first opening.

According to some embodiments of the application, the base comprises a base body and a plurality of clamping members on an edge of the base body, and the plurality of clamping members are configured to engage the second control board to the base.

According to some embodiments of the application, the clamping member comprises a second connection section and a second clamping section, one end of the second connection section is connected to the base body, and the other end of the second connection section is connected to the second clamping section, the second clamping section is disposed opposite to the base body, and the second control board is disposed between the base body and the second clamping section.

According to some embodiments of the application, the display device further comprises a mounting shell and a module backplane for supporting the display module of the display device, the camera module and the second control board are disposed within the mounting shell, and the mounting shell is connected to the side frame and the module backplane, respectively.

Some embodiments of the application have been summarized above. Other different embodiments can be obtained based on the combination of some embodiments and the combination of features in different embodiments, and these different embodiments also fall within the protection scope of the application.

### BRIEF DESCRIPTION OF THE DRAWINGS

In order to illustrate the technical solutions in embodiments of the application more clearly, the drawings for description of the embodiments will be briefly introduced below. Obviously, the drawings in the description below are some embodiments of the application. For those of ordinary skill in the art, other drawings may be further obtained based on these drawings without creative effort.

FIG. 1 illustrates an exploded perspective view of some components in a display device provided by an embodiment of the application;

FIG. 2 illustrates a sectional view of a camera module in a display device provided by an embodiment of the application;

FIG. 3 illustrates a partial side view of a display device provided by an embodiment of the application, as viewed from a second side wall of the frame;

FIG. 4 illustrates a partial enlarged view of the second side wall of the frame in the display device provided by an embodiment of the application;

FIG. 5 illustrates views of the bracket in the camera module mounting assembly provided by an embodiment of the application viewed from different angles,

FIG. 6 illustrates a mounting portion in the camera module mounting assembly provided by an embodiment of the application;

FIG. 7 illustrates a partial sectional view of the mounting portion and the camera in the camera module provided by another embodiment of the application;

FIG. 8 illustrates a view in which the mounting portion and the camera in the camera module provided by another embodiment of the application are combined with each other;

FIG. 9 illustrates two microphone array strips in a display device provided by an embodiment of the application;

FIG. 10 illustrates a partial perspective view of the frame of a display device provided by another embodiment of the application, as viewed from a second side wall of the frame;

FIG. 11 illustrates a spatial layout of a camera, a microphone array strip, and a first control board in a display device provided by another embodiment of the application;

FIG. 12 illustrates views of a first adapter or a second adapter in a display device provided by another embodiment of the application at different viewing angles;

FIG. 13 illustrates a view in which a first adapter or a second adapter combined with a single microphone array strip in a display device provided by another embodiment of the application;

FIG. 14 illustrates a side view when the first adapter and the microphone array strip in a display device are assembled to the frame;

FIG. 15 illustrates a partial enlarged view of the microphone array strip and the first side wall of the frame in FIG. 14;

FIG. 16 illustrates a support member for supporting a first control board in a display device according to an embodiment of the application;

FIG. 17 illustrates a view when a support member is combined with two adapters in a display device according to an embodiment of the application;

FIG. 18 illustrates a view of a second side wall of a frame and a module backplane for a display device according to an embodiment of the application;

FIG. 19 illustrates an enlarged view of the area indicated with “B” in FIG. 18;

FIG. 20 illustrates a partial view of a display device according to an embodiment of the application as viewed from the second side wall of the frame;

FIG. 21 illustrates a partial view of a display device according to another embodiment of the application as viewed from the second side wall of the frame;

FIG. 22 illustrates a partial structural view of a camera module mounting assembly provided by another embodiment of the application;

FIG. 23 illustrates a structural view of a camera module mounting assembly provided by another embodiment of the application;

FIG. 24 illustrates a partial enlarged view of a mounting portion in the camera module mounting assembly provided by another embodiment of the application;

FIG. 25 illustrates a bracket in the camera module mounting assembly provided by another embodiment of the application;

FIG. 26 illustrates a sectional view of a camera and a bracket in the camera module provided by another embodiment of the application;

FIG. 27 illustrates a structural view of a base and a second control board in the camera module mounting assembly provided by another embodiment of the application;

FIG. 28 illustrates an enlarged view of the area indicated with “E” in the structural view of a base and a second control board shown in FIG. 27;

FIG. 29 illustrates a partial structural view of a display device provided by a further embodiment of the application.

### DETAILED DESCRIPTION OF EMBODIMENTS

The technical solutions in embodiments of the application will be clearly and comprehensively described below with reference to the accompanying drawings in the embodiments of the application. Obviously, the described embodiments are only some of the embodiments of the application, rather than all of them. All other embodiments obtained by those of ordinary skill in the art based on the embodiments of the application without creative effort fall within the protection scope of the application.

It is to be noted that all instructions or descriptions about directions in the embodiments of the application are based on the relatively positional relationships of components of the display device illustrated in the drawings, and the drawings are mainly used to schematically illustrate the relative positions and spatial layout of relevant components of the display device, but do not represent the component structures and sizes in an actual product.

In the application, unless otherwise expressly specified and limited, the terms such as “connect”, “connection”, “connected” and “fix” should be understood in a broad sense. For example, “connection” of two components may mean that the two components are fixedly connected, or that the two components are detachably connected, or that the two components are formed into one piece. “Connection” may indicate that the two components are directly connected or in direct contact, and may also include the case that the two components are connected to each other via an intermediate component. The “fixing” of one component to another may be the result of “connection” of the two components to each other, and may also indicate that the two components are formed as a single piece. For those of ordinary skill in the art, specific meanings of the above terms in the application can be understood according to specific circumstances. In addition, descriptions involving “first”, “second”, etc. in the application are only for the purpose of distinguishing different technical features conveniently, and cannot be understood as indicating or implying their relative importance or implicitly indicating the number of indicated features. Therefore, the technical features defined with “first” and “second” may explicitly or implicitly include at least one of these features. In addition, technical solutions of the embodiments may be combined with each other, and various different technical solutions obtained by those of ordinary skill in the art based on the technical solutions of different embodiments of the application also fall within the disclosure of the application.

An embodiment of the application provides a display device. The display device comprises a frame and a camera module. The frame is used to carry an internal module of the display device, and the camera module includes a camera and a camera module mounting assembly. The internal module includes the camera module, the camera module mounting assembly includes a bracket and a mounting portion, and the mounting portion is configured to be detachably connected to the bracket. When the bracket is connected to the mounting portion, the bracket and the mounting portion form a first cavity for accommodating the camera, and the mounting portion is connected to the frame to assemble the bracket and the camera to the frame.

The display device mentioned herein refers to any device with image display function. Examples of display devices include but are not limited to televisions, mobile devices, all-in-one conference machines, electronic blackboards used in teaching, and the like. The “frame” mentioned here may refer to an integral assembly of a display device for packaging its internal modules and display screen. For example, the frame may include a side frame of the display device, a module backplane for supporting a display module (for example, backlight module) of the display device, and a back cover of the display device, etc. Alternatively, the frame may only refer to a portion of the above-mentioned integral assembly. For example, the frame may only include the aforementioned side frame. The side frame refers to a frame structure arranged on the outer edge of the display device. The frame may play the role of protecting and fixing the screen and internal modules of the display device. In some embodiments, the frame also generally defines the image display area of the display device. The side frame may extend along at least a portion of the perimeter or outer edge of the display device. For example, for a display device having an approximately rectangular outline, the side frame may be located at any one of the rectangular outer edges of the display device, and the side frame may extend along the entirety or part of any edge. The internal modules mentioned herein refer to modules located inside the frame of the display device and used to implement the display function or other additional functions of the display device. For example, the internal modules may include at least a portion of a display panel that achieves basic image display function, a touch module that implements touch function, and a backlight module that provides backlight.

The camera module mounting assembly not only serves as a mounting assembly to configure the camera to the frame of the display device, but the camera module mounting assembly and the camera may be integrated into a camera module, so that the camera and camera module mounting assembly are combined into a single module, which helps to realize a smaller overall volume of the camera and camera module mounting assembly, and makes it convenient to assemble the camera and the camera module mounting assembly to the frame of the display device. In addition, the characteristic of a detachable connection between the mounting portion and the bracket further facilitates assembly and disassembly between the frame and the camera of the display device,

Specific implementations of the display device provided by the above embodiment will be further described below through specific examples. For the sake of brevity, in the description below, specific description will be made by taking an example in which the frame includes a side frame extending along at least a portion of the periphery of the display device.

FIG. 1 illustrates an exploded view of some components in a display device according to an embodiment of the application, but the frame of the display device is not shown in FIG. 1. As shown in FIG. 1, the camera module in the display device comprises a camera 122 and a camera module mounting assembly 110. The camera module mounting assembly 110 comprises a bracket 124 and a mounting portion 114. The mounting portion 114 is detachably connected to the bracket 124. When the bracket 124 is connected to the mounting portion 114, the bracket 124 and the mounting portion 114 form a first cavity for accommodating the camera 122. As will be described further below, the mounting portion 114 may be connected to the frame of the display device, thereby assembling the bracket 124 and camera 122 to the frame.

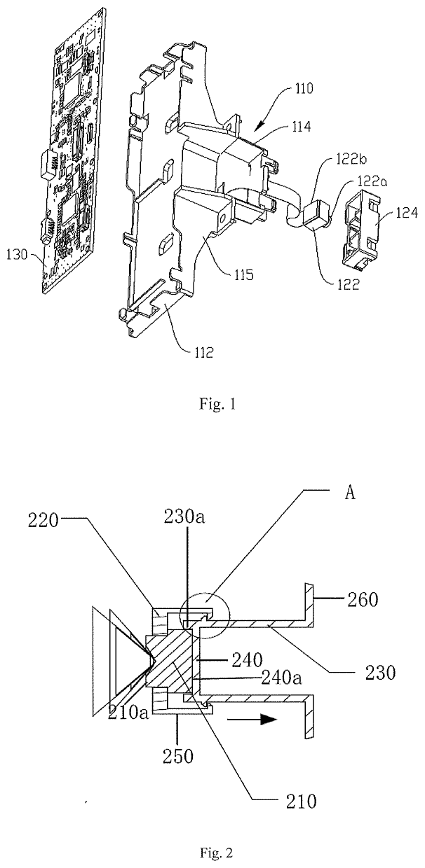

FIG. 2 illustrates a camera and a camera module mounting assembly in a display device according to another embodiment of the application. As shown in FIG. 2, the camera module in the display device comprises a camera 210 and a camera module mounting assembly. The camera module mounting assembly comprises a bracket (the main body of the bracket is labelled as 220 in FIG. 2) and a mounting portion (the main body of the mounting portion is labelled as 230 in FIG. 2), and the mounting portion is detachably connected to the bracket. FIG. 2 illustrates a sectional view when the mounting portion and the bracket are connected to each other, and the camera 210 is accommodated in the first cavity formed by the bracket and the mounting portion. In FIG. 2, the triangles on the left side of the camera 210 are used to illustrate the image capturing angle ranges of the camera and does not represent specific elements of the camera. In addition, the application does not impose any restriction on the specific form of the “first cavity” that accommodates the camera. The first cavity may be a completely enclosed space or a semi-enclosed space with an opening or a through hole.

As previously mentioned, the frame of the display device may include a side frame extending along at least a portion of the periphery of the display device. According to some embodiments of the application, a side frame of the display device may include a cavity. A camera module including a camera and a camera module mounting assembly may be assembled to the cavity of the side frame. In some embodiments, the side frame includes a first side wall, a second side wall and a third side wall. The first side wall and the second side wall face each other, and the third side wall is connected to the first side wall and the second side wall respectively to form a second cavity. The first side wall includes a first opening, the second side wall includes a second opening. The camera module mounting assembly passes through the second cavity via the second opening and extends to the first opening, so that the image capturing surface (shown as 122a in FIG. 1) of the camera in the first cavity is exposed via the first opening, and the mounting portion is connected to the second side wall of the side frame. The image capturing surface mentioned herein refers to a surface of the camera that faces toward an object when capturing images or videos of the object. The first opening mentioned here is formed in the second side wall of the side frame. It can be understood that the side frame of the display device may include other accessories covering the first opening. For example, a transparent cover plate may be provided on the first opening to protect the camera without substantially affecting the image acquisition function of the camera.

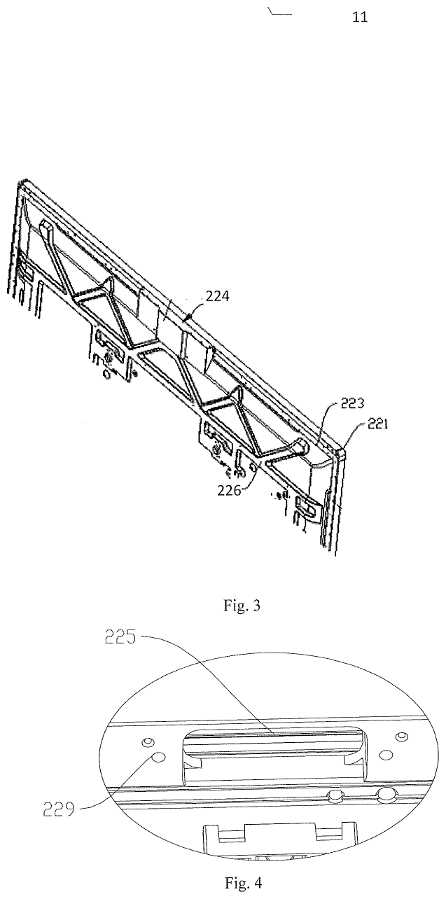

FIG. 3 schematically shows a partial structural view of the frame of the display device. Specifically, FIG. 3 illustrates a portion of the side frame and module backplane mentioned previously. As shown in FIG. 3, the side frame of the display device comprises a first side wall 221 and a second side wall 223. When a user is operating the display device, the first side wall 221 may directly face the user, and at that time, the second side wall 223 may be invisible to the user. The first side wall 221 includes a first opening, and the second side wall 223 includes a second opening. The existence of the first opening and the second opening may form a mounting slot for placing the camera module mounting assembly in the second cavity. FIG. 4 schematically shows a partial enlarged view of the second side wall of the frame, and the above-mentioned mounting slot is shown by 225 in FIG. 4.

According to some embodiments of the application, the aforementioned mounting portion includes a first positioning portion, the bracket includes a second positioning portion, and the first positioning portion cooperates with the second positioning portion to connect the mounting portion and the bracket. As will be explained in detail below, the first positioning portion and the second positioning portion may be implemented in a variety of different forms. For example, in some embodiments, one of the first positioning portion and the second positioning portion includes a buckle, and the other of the first positioning portion and the second positioning portion includes a protrusion that matches the buckle. The buckle mates with the protrusion to connect the mounting portion and the bracket.

In some embodiments, the bracket further includes a bracket body connected to the second positioning portion, the bracket body includes a bracket through hole penetrating the bracket body, and the image capturing surface of the camera is exposed via the bracket through hole. In FIG. 1, the bracket through hole is located at the central position of the main body of the bracket 124. In FIG. 2, the bracket through hole is also located at the middle position of the bracket body 220. The term “exposed” mentioned here means that the image capturing surface of the camera is not covered by the bracket body, thereby ensuring the normal operation of the image collection function of the camera. Referring back to FIG. 2, according to some embodiments of the application, the bracket in the camera module mounting assembly includes a bracket body 220 and a bracket connector 250 extending and protruding from an edge of the bracket body 220 in a direction perpendicular to the plane of the bracket body 220, that is, the second positioning portion includes a bracket connector extending and protruding from an edge of the bracket body in a direction perpendicular to the plane of the bracket body. When the bracket is connected to the mounting portion in the camera module mounting assembly via the bracket connector 250, the bracket body, the bracket connector and the first positioning portion of the mounting portion form the first cavity mentioned previously.

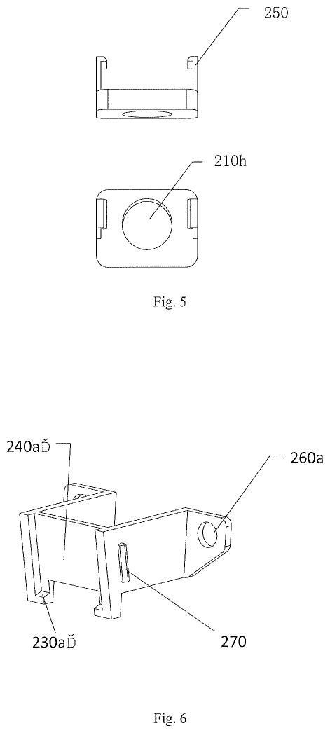

Further, as shown in FIG. 2, the camera 210 includes an image capturing surface 210a, a back surface directly opposite to the image capturing surface 210a, and a side surface adjacent to the back surface. The first positioning portion of the mounting portion includes a first support surface 240a for supporting the back surface and a second support surface 230a for supporting a portion of the side surface. When the bracket is connected to the mounting portion via the bracket connector 250, the bracket body 220, the bracket connector 250, the first support surface 240a and the second support surface 230a form a first cavity for accommodating the camera 210. As shown in FIG. 2, the bracket body 220 includes a bracket through hole penetrating the bracket body, and the image capturing surface of the camera 210 can be exposed via the bracket through hole. In the example of FIG. 2, the camera 210 includes a first portion and a second portion connected to each other. The diameter of the sectional view of the first portion is smaller than the diameter of the sectional view of the second portion. The first portion of the camera 210 is exposed after passing through the bracket through hole of the bracket body 220. The image capturing surface of the camera is an outer surface of the first portion, and the back surface of the camera is a surface of the second portion. The specific way of connection between the bracket connector and the mounting portion is not limited in the embodiment of the application. In some embodiments, the bracket connector of the second positioning portion includes a buckle, the first positioning portion includes a first positioning portion body and a protrusion, the first positioning portion body includes the first support surface and the second support surface, and the protrusion extends and protrudes from a surface of the first positioning portion body facing the second support surface in a direction facing away from the second support surface. In the example of FIG. 2, the bracket connector 220 includes a buckle, and the mounting portion includes a protrusion that matches the buckle. As shown in the region indicated by A in FIG. 2, the buckle of the bracket connector 220 and the protrusion of the mounting portion 230 mates with each other to connect the bracket and the mounting portion to each other. The bracket may also be separated from the mounting portion via the bracket connector 250. In the example of FIG. 2, the first positioning portion body includes a support structure 240 that provides the first support surface 240a and the second support surface 230a. The support structure 240 may include a first sub-support structure and a second sub-support structure extending in different directions and the first sub-support structure and the second sub-support structure may be perpendicular to each other and formed into one piece. The protrusion in the first positioning portion extends and protrudes from a surface of the first positioning portion body facing the second support surface 230a in a direction facing away from the second support surface 230a. In some embodiments, as shown in FIG. 5, the bracket may also be implemented in the form of a camera cover. The camera cover includes a bracket body and a bracket connector 250, and the bracket body includes a bracket through hole 210h.

Referring back to FIG. 2, in some embodiments, the mounting portion in the camera module mounting assembly includes a mounting portion body 230 connected to the first positioning portion (including the first positioning portion body and the protrusion extending and protruding from the first positioning portion body). The first positioning portion body includes a support structure 240, and the support structure 240 includes a first sub-support structure and a second sub-support structure that provide the first support surface 240a and the second support surface 230a respectively. An extension direction of the mounting portion body 230 is substantially consistent with a width direction of the third side wall pointing from the second side wall to the first side wall, as shown by the arrow in FIG. 2. In the example of FIG. 2, the first sub-support structure providing the first support surface 240a is generally perpendicular to the mounting portion body 230. In addition to the mounting portion body 230 and the first positioning portion, the mounting portion further includes a connector 260 connected to the mounting portion body 230. The connector 260 extends along an edge of one end of the mounting portion body 230 and is perpendicular to the mounting portion body 230. The connector 260 may be connected to the second side wall of the side frame. For example, the connector 260 may include a connector through hole, and the second side wall of the side frame may include a via hole corresponding to the connector through hole, so that the mounting portion is fixed to the second side wall of the side frame by means of fasteners such as screws. Correspondingly, the bracket and the camera in the first cavity are also connected to the side frame.

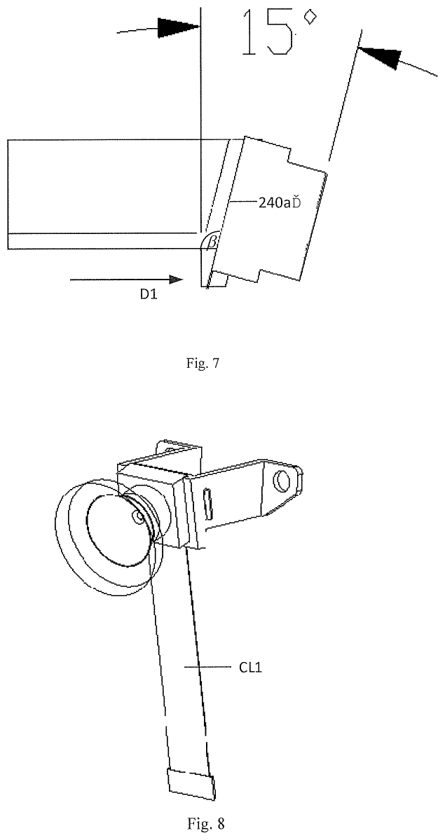

FIGS. 6 and 7 illustrate the structure of a mounting portion in a camera module mounting assembly of a display device according to another embodiment of the application. Similar to the embodiment described with reference to FIG. 2, the mounting portion includes a mounting portion body and a first positioning portion connected to the mounting portion body. The first positioning portion body includes a first support surface 240a′ and a second support surface 230a′. The first support surface 240a′ and the second support surface 230a′ are respectively used to support a portion of the back surface of the camera and the side surface adjacent to the back surface discussed previously. An extension direction of the mounting portion body is substantially consistent with a width direction of the third side wall of the side frame pointing from the second side wall to the first side wall, as shown by the arrow D1 in FIG. 7. However, unlike the embodiment shown in FIG. 2, the first support surface 240a′ is not perpendicular to the extension direction of the mounting portion body. The first support surface 240a′ forms an obtuse angle with respect to the extension direction of the mounting portion body. In some embodiments, the first support surface forms an included angle of 105 to 115 degrees with respect to an extension direction D1 of the mounting portion body. For example, as shown in FIG. 7, the first support surface 240a′ is not perpendicular to the extension direction D1 of the mounting portion body, but deviates by 15 degrees from the vertical direction perpendicular to the extension direction D1 of the mounting portion body, thus the first support surface forms an included angle of 115 degrees with respect to the extension direction D1 of the mounting portion body. As a result, when the camera module is assembled to the side frame of the display device, the image capturing surface of the camera is not parallel to the plane of the first side wall of the side frame of the display device, but tilts at a certain angle (for example, 15 to 25 degrees) towards the user with respect to the plane of the first side wall, so that the camera can capture images of regions that include more target objects (for example, humans) as much as possible when the user is running the display device. FIG. 6 further illustrates a protrusion 270 of the mounting portion for mating connection with the bracket and a connector through hole 260a in the connector of the mounting portion. The protrusion 270 may mate with the buckle of the bracket in the previous embodiment so as to connect the bracket to the mounting portion, the connector extends along an edge of one end of the mounting portion body and is perpendicular to the mounting portion body, and the connector may be connected to the second side wall of the side frame by means of the connector through hole 260a.

FIG. 8 illustrates a circumstance when the camera and the mounting portion are combined with each other. FIG. 8 further shows a camera connection line CL1. The camera connection line may be electrically connected to a controller (such as a first control board to be discussed below) in the display device, thus the first control board can perform signal transmission with the camera, receive signals acquired by the camera or transmit relevant control signals to the camera.

According to another embodiment of the application, in addition to the camera module, the display device further comprises a microphone array module and a microphone array mounting assembly for assembling the microphone array module to the side frame. The microphone array mounting assembly is connected to the second side wall of the side frame, and the microphone array module is disposed between the microphone array mounting assembly and the first side wall.

In some embodiments, the microphone array module includes at least one microphone array strip, and the microphone array mounting assembly includes at least one adapter that connects respective one of the at least one microphone array strip to the side frame respectively. Each adapter includes at least one presser and at least one hanger, the hanger is connected to a surface of the second side wall facing away from the first side wall, and the presser is connected to a surface of the microphone array strip facing away from the first side wall. The microphone array strip mentioned here may also be understood as a microphone array board. The microphone array strip is in a strip shape as a whole and has multiple microphones integrated therein. When the microphone array module is assembled to the side frame, a length direction of the microphone array strip may be consistent with a length direction of the first side wall or the second side wall of the side frame. As a result, the functions of the display device can be further enriched, and a solution for accommodating the camera and microphone array modules within the frame of the display device is provided, which rationally utilizes the space of the second cavity of the side frame, and realizes efficient integration of the camera and the microphone array module in the frame of the display device.

In some embodiments, each of the at least one adapter includes an adapter body, and the at least one presser extends and protrudes from a first edge of the adapter body along a first direction intersecting the plane of the adapter body. At least some of the at least one presser includes a presser body and a presser positioning column, and the presser positioning column extends and protrudes from the presser body in a second direction parallel to the plane of the adapter body. The microphone array strip includes at least one via hole, and the presser positioning column passes through a corresponding via hole of the at least one via hole to position the at least one microphone array strip to the at least one adapter. With such an adapter, the mounting location of the microphone array strip on the side frame can be accurately positioned, and the stability of the assembly between the microphone array strip and the side frame is also enhanced.

According to another embodiment of the application, the display device further comprises a first control board electrically connected to the microphone array module and a support member for supporting the first control board. The adapter further includes a bridge structure, the bridge structure extends and protrudes from the edge of the adapter body along a third direction opposite to the first direction, and the support member is connected to the bridge structure of the adapter so as to fix the first control board to the side frame via the support member and the adapter. As a result, the first control board and the microphone array strip are connected into an entirety through the adapter and the support member, and the entirety of the first control board and the microphone array strip can be reliably assembled to the side frame of the display device.

In some embodiments, the at least one microphone array strip includes a first microphone array strip and a second microphone array strip. The length extension direction of each of the first microphone array strip and the second microphone array strip is consistent with the length extension direction of the first side wall of the side frame, and the first microphone array strip and the second microphone array strip are located on two sides of the camera module respectively in the length extension direction of the first side wall.

Next, a microphone array module including a first microphone array strip and a second microphone array strip is taken as an example to further illustrate the way of assembly between the microphone array module and the side frame and the way of assembly between the microphone array module and the first control board.

In some embodiments, each microphone array strip of the first microphone array strip and the second microphone array strip includes a plurality of microphones and a plurality of sound receiving holes corresponding to the plurality of microphones. The plurality of sound receiving holes are arranged along the length direction of the microphone array strip, and a distance between any two adjacent sound receiving holes in the first microphone array strip or the second microphone array strip along the length extension direction of the first side wall is equal to the distance between two sound receiving holes in the first microphone array strip and the second microphone array strip which are closest to each other along the length extension direction.

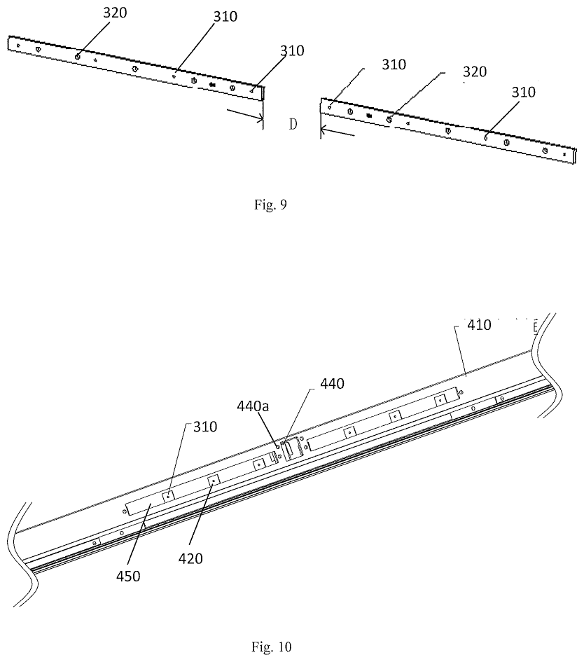

FIG. 9 illustrates two microphone array strips, each of which includes a plurality of sound receiving holes 310 and at least one via hole 320. The distances between every two adjacent sound receiving holes 310 are the same along the length direction of the microphone array strip. The length extension direction of each of the first microphone array strip and the second microphone array strip is consistent with the length extension direction of the first side wall of the side frame, and the first microphone array strip and the second microphone array strip are located on two sides of the camera module respectively in the length direction of the first side wall. FIG. 10 illustrates a partial side view of a side frame of a display device according to an embodiment of the application, as viewed from the second side wall of the side frame. In other words, FIG. 10 can also be understood as a partial perspective view of the second side wall of the side frame. FIG. 10 illustrates a second opening 440 in the second side wall 410 of the side frame discussed above, through which the camera module mounting assembly can pass through the second cavity of the side frame and extend to the first opening (not shown in FIG. 10) of the first side wall, so that the image capturing surface of the camera in the first cavity in the camera module mounting assembly can be exposed via the first opening. FIG. 10 further illustrates a component 440a near the second opening 440 for connecting the mounting portion to the second side wall 410 of the side frame. The component 440a may include, for example, a via hole that may mate with the connector through hole 260a of the mounting portion, so that the mounting portion can be fixed to the second side wall 410 of the side frame using a connection device such as a screw. Reference sign 450 in FIG. 10 represents a mounting slot that facilitates mounting the first microphone array strip or the second microphone array strip to the side frame. Two mounting slots 450 are provided on two sides of the second opening 440 respectively, and the mounting slots 450 penetrate the second side wall 410 of the side frame, so that the first microphone array strip and the second microphone array strip are visible from the second side wall. In FIG. 10, the first microphone array strip and the second microphone array strip have been placed on the first side wall of the side frame.

In some embodiments, after the first microphone array strip and the second microphone array strip are assembled to the side frame via the microphone array mounting assembly, the distance between any two adjacent sound receiving holes in the first microphone array strip and the second microphone array strip along the length extension direction of the first side wall is equal to the distance between two sound receiving holes in the first microphone array strip and the second microphone array strip which are closest to each other along the length extension direction. In some embodiments, the distance between any two adjacent sound receiving holes in the first microphone array strip or the second microphone array strip along the length extension direction of the first side wall is 40 mm, and the distance between two opposite ends of the first microphone array strip and the second microphone array strip is 30 mm (for example, as shown by the distance D in FIG. 9), so that the distance between the two sound receiving holes in the first microphone array strip and the second microphone array strip which are closest to each other along the length extension direction is also 40 mm. This will help to improve sound signal acquisition when the microphone array module is in operation.

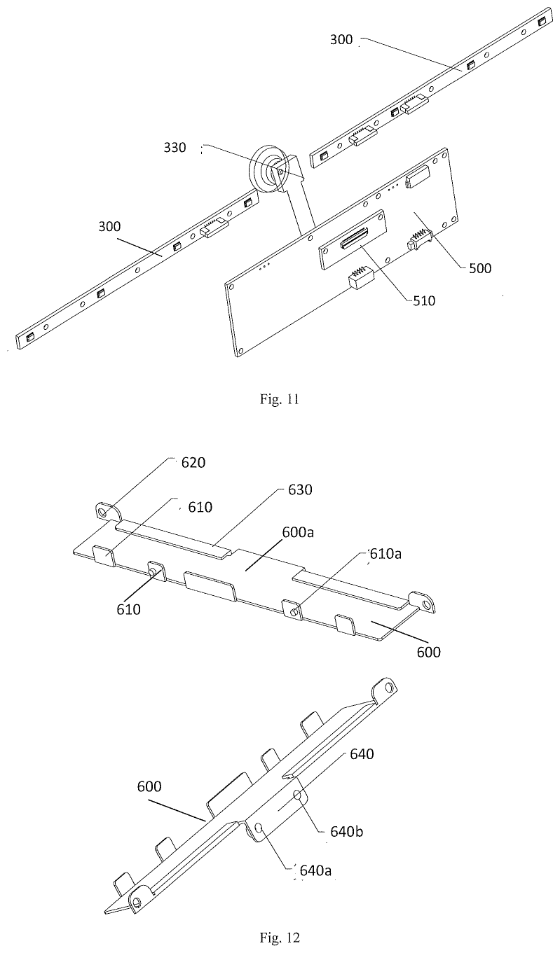

FIG. 11 illustrates a spatial arrangement of the camera and the microphone array strips in the side frame according to an embodiment of the application. As shown in FIG. 11, the first microphone array strip and the second microphone array strip 300 are located on two sides of the camera 330 respectively in the length extension direction of the first side wall of the side frame, the first microphone array strip or the second microphone array strip.

In the case where the microphone array module includes a first microphone array strip and a second microphone array strip, the at least one adapter may include a first adapter and a second adapter for connecting the first microphone array strip and the second microphone array strip to the side frame respectively, and each hanger in the first adapter and the second adapter extends and protrudes from a second edge of the adapter body directly opposite to the first edge thereof along the first direction.

An example of an implementation of fixing the microphone array module to the side frame will be further described in detail below with reference to FIGS. 12, 13, 14 and 9.

As shown in FIG. 9, each of the first microphone array strip and the second microphone array strip includes at least one via hole 320, and the microphone array mounting assembly includes a first adapter and a second adapter for connecting the first microphone array strip and the second microphone array strip to the side frame respectively. The first adapter and the second adapter have the same structure and are identified as 600 in FIGS. 12 and 13. Each of the first adapter and the second adapter includes an adapter body 600a and a plurality of pressers 610 extending and protruding from the adapter body 600a. Each presser 610 extends from a first edge of the adapter body 600a along a first direction intersecting a plane where the adapter body 600a is located. For example, the first direction may be perpendicular to a plane where the adapter body 600a is located. As shown in FIG. 12, at least some pressers 610 of the plurality of pressers include a presser body and a presser positioning column 610a. The presser positioning column 610a extends and protrudes from the presser body in a second direction parallel to the plane where the adapter body 600a is located. The pressing positioning column 610a shown in FIG. 12 can pass through a corresponding via hole 320 of the at least one via hole of the first microphone array strip or the second microphone array strip shown in FIG. 9 so as to position the first microphone array strip or the second microphone array strip to the first adapter or the second adapter. More specifically, through the matching between the pressing positioning column 610a and the corresponding via hole 320 in the first microphone array strip or the second microphone array strip, the first microphone array strip or the second microphone array strip may align with the presser of the first adapter or the second adapter in a desired manner. At that time, the first microphone array strip or the second microphone array strip can be connected to the presser of the first adapter or the second adapter respectively using an adhesive or other materials. For example, FIG. 13 illustrates a view of the first microphone array strip 300 being connected to the presser of the first adapter 600.

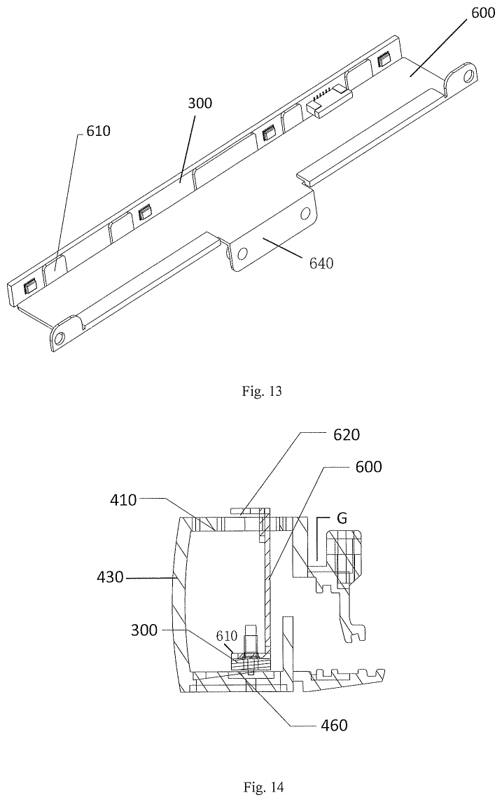

Continuing to refer to FIG. 12 or 13, each of the first adapter and the second adapter further includes at least one hanger 620, and each hanger 620 extends and protrudes from a second edge of the adapter body 600a directly opposite to the first edge along the first direction. The hanger 620 may be connected to a surface of the second side wall of the side frame facing away from the first side wall of the side frame. FIG. 14 illustrates a side view of the first adapter 600 and the first microphone array strip 300 when they are assembled to the side frame. Specifically, the side view is a view viewed from an end surface of the side frame perpendicular to the length extension direction of the first side wall or the second side wall. As shown in FIG. 14, the side frame includes a first side wall 460, a second side wall 410, and a third side wall 430 connecting the first side wall and the second side wall. The hanger 620 may be connected to a surface of the second side wall 410 of the side frame facing away from the first side wall 460 of the side frame. The hanger 620 may include a hanger through hole, so that the hanger 620 may be connected to the surface of the second side wall 410 facing away from the first side wall 460 of the side frame via the hanger through hole by means of a screw or stud. As shown in FIG. 14, the first microphone array strip 300 is connected to the presser 610 of the first adapter 600. When the hanger 620 is tightly attached to the second side wall 410 of the side frame through a screw or stud, the first microphone array strip 300 may be in contact with the first side wall 460 of the side frame, or there may be only a small gap (the size of the gap is, for example, 0.2 mm or less) between the first microphone array strip 300 and the inner surface of the first side wall 460 facing the second side wall 410. As shown in FIG. 12, in some embodiments, the first adapter and the second adapter may further include a flanging structure 630, and the flanging structure 630 extends from the second edge of the adapter body 600a towards the first edge of the adapter body 600a. The flanging structure 630 helps to enhance the overall strength of the first adapter and the second adapter.

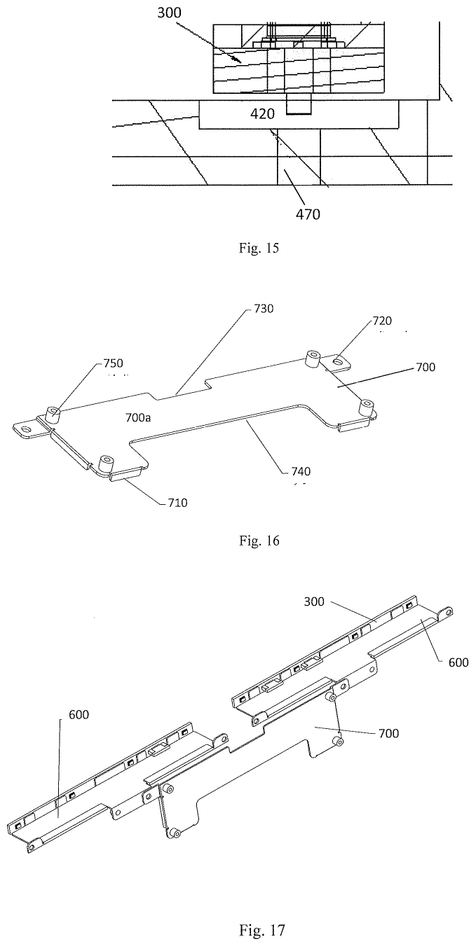

FIG. 15 illustrates a partial enlarged view of the first microphone array strip 300 and the first side wall 460 of the side frame in FIG. 14. As shown in FIG. 15, the first side wall 460 of the side frame may include a plurality of grooves 420 in one-to-one correspondence with the plurality of sound receiving holes of the first microphone array strip 300, and each groove 420 is used to accommodate an acoustic foam. The first side wall 460 further includes a plurality of side wall through holes 470 in one-to-one correspondence with the plurality of grooves 420, each side wall through hole 470 extends from a bottom surface of the groove 420 close to the outer surface of the side wall 460 to the outer surface of the first side wall 460. As a result, an independent sound channel can be formed for each microphone in the first microphone array strip, and interference or crosstalk between sound channels of different microphones can be reduced. Furthermore, the sectional area or volume of each groove 420 may be larger than the sectional area or volume of a corresponding sound receiving hole of the plurality of sound receiving holes of the first microphone array strip 300.

According to some embodiments of the application, the display device further comprises a first control board electrically connected to the microphone array module and a support member for supporting the first control board. Each of the first adapter and the second adapter further includes a bridge structure extending and protruding from the second edge of the adapter body along a third direction opposite to the first direction. The support member is connected to the bridge structures of the first adapter and the second adapter respectively so as to fix the first control board to the side frame via the support member, the first adapter and the second adapter. FIG. 11 illustrates the first control board 500. The first control board 500 is electrically connected to the first and second microphone array strips 300 in the microphone array module to receive sound signals acquired by the microphones in the microphone array strips so as to process the acquired sound signals. Further, the first control board may be electrically connected to a host controller (for example, a mainboard) of the display device, and the host controller further processes or transmits the processed sound. FIG. 11 further illustrates a sub-control board 510 on the first control board 500. The sub-control board 510 is electrically connected to the camera 330 and the first control board 500 respectively, and is configured to realize signal transmission and processing between the camera 330 and the first control board. In other embodiments, the first control board 500 and the sub-control board 510 may be integrated into a single control board. FIGS. 12 and 13 illustrate a bridge structure 640 in the first adapter and the second adapter, and the bridge structure may include through holes 640a, 640b.

FIG. 16 illustrates an example of a support member. The support member includes a support body 700a and a support hanger 720. The support hanger 720 may be connected to a corresponding through hole (for example, 640a or 640 b) in the bridge structure of the first adapter or the second adapter, so that the first control board supported by the support member is fixed to the side frame via the support member, the first adapter and the second adapter. As shown in FIG. 16, the support member 700 may further include a stud 750 for connecting the first control board, and a plurality of studs 750 may be distributed on the periphery of the support body 700a. The support member may include two support hangers 720 respectively located on two edges of the support body 700a facing each other. FIG. 17 illustrates a view in which a support member 700, two adapters 600 (the first adapter and the second adapter described previously) and two microphone array strips 300 (the first and second microphone array strips described previously) are connected to one another. One support hanger 720 of the support member 700 may be connected to a through hole in the bridge structure of the first adapter, and the other support hanger 720 of the support member 700 may be connected to a through hole in the bridge structure of the second adapter, so that the support member 700 and two adapters are connected into an entirety.

According to some embodiments of the application, the display device further comprises a display module and a module backplane for supporting the display module. The support member includes a support body and a lateral rib, and the lateral rib extends and protrudes from at least a portion of the edge of the support body in a fourth direction intersecting the plane of the support body, so as to abut on a surface of the module backplane facing away from the display module. The display module may include a component for realizing the image display function of a display device. For example, for a liquid crystal display device, the display module at least includes a backlight module. For an organic light-emitting display device, the display module may include an array substrate. In this embodiment, as shown in FIG. 16, the support member 700 further includes a lateral rib 710 extending and protruding from at least a portion of the edge of the support body 700a in a fourth direction intersecting the plane of the support body 700a so as to abut on a surface of the module backplane facing away from the display module. It can be understood from the foregoing embodiments that the microphone array module, the first adapter, the second adapter and the support member may be connected into an integrated structure, and the integrated structure may be fixed to the side frame of the display device via the first adapter and the second adapter. With the lateral rib of the support member, the integrated structure may abut on the surface of the module backplane via the lateral rib, so that the reliability and stability of the integrated structure and the spatial layout of the first control board supported by the support member in the display device can be further enhanced.

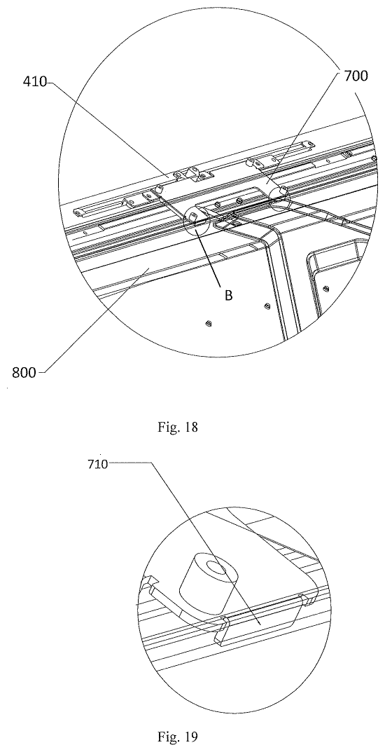

FIG. 18 illustrates a view of the second side wall of the side frame and the module backplane for the display device. As shown in FIG. 18, the support member 700 has been connected to the second side wall 410 of the side frame and a module backplane 800. FIG. 19 illustrates an enlarged view of the area indicated with “B” in FIG. 18. An interference fit between the lateral rib 710 of the support member 700 and the surface of the module backplane facing away from the display module is formed, thereby achieving stable support of the support member 700 by the module backplane 800.

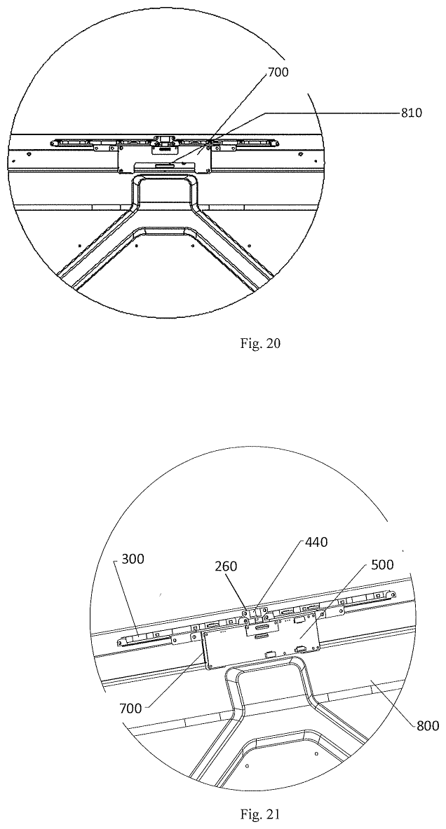

According to some embodiments of the application, the camera may be electrically connected to the first control board 500 via the camera connection line, and the first control board is electrically connected to the mainboard of the display device via the control board connection line. In this embodiment, as shown in FIG. 16, the support body 700a includes a first notch 730 on a first side of the support body and a second notch 740 on a second side of the support body. The first side is directly opposite to the second side. Correspondingly, the module backplane includes a backplane opening corresponding to the second notch 740. The first notch 730 is configured to allow the camera connection line to pass through, and the second notch 740 and the backplane opening are configured to allow the control board connection line to pass through. As a result, the camera connection lines and the control board connection lines can be arranged in an orderly manner in the display device, and intersections between different connection lines can be avoided. FIG. 20 illustrates a backplane opening 810 in the module backplane. At that time, the support member 700 has been connected to the side frame by means of the first adapter and the second adapter, and the first control board 500 has not yet been fixed to the support member 700. It can be seen from FIG. 20 that the backplane opening 810 basically corresponds to the second opening of the support body. FIG. 21 illustrates a circumstance when the first control board 500 is connected to the support member 700. FIG. 21 also illustrates the microphone array strip 300 connected to the side frame of the display device, the second opening 440 for placing the camera module mounting assembly, and the connector 260 of the mounting portion in the camera module mounting assembly discussed previously.

According to another embodiment of the application, the camera module mounting assembly further includes a base connected to the mounting portion, the display device includes a second control board electrically connected to the camera, the second control board and the mounting portion are connected to two opposite sides of the base respectively, and the bracket is configured to be detachably connected to a side of the mounting portion facing away from the base.

Referring back to FIG. 1, the second control board 130 may be electrically connected to the camera 122 to receive image signals acquired by the camera 122 and send related instructions to the camera 122. The second control board 130 and the mounting portion 114 are connected to two opposite sides of the base 112 respectively, and the bracket 124 is configured to be detachably connected to a side of the mounting portion 114 facing away from the base 112. The camera 122 includes an image capturing surface 122a and a back surface 122b directly opposite to the image capturing surface 122a. In the example of FIG. 1, the image capturing surface 122a is a surface of the camera 122 facing away from the base 112. As stated above, the camera module mounting assembly 110 includes a bracket 124 and a mounting portion 114, and the mounting portion 114 is detachably connected to the bracket 124. When the bracket 124 is connected to the mounting portion 114, the bracket 124 and the mounting portion 114 form a first cavity for accommodating the camera 122. In this embodiment, the bracket 124, the camera 122, and the second control board 130 may all be connected to the base 112 and the mounting portion 114. The base 112 and the mounting portion 114 may be connected to each other or integrally formed, so as to enable the second control board and the camera module including the camera and the camera module mounting assembly to be formed into one piece, so that the camera module and the second control board can be assembled to the side frame of the display device at one time, which reduces the component mounting steps and mounting workload of the display device, and also decreases the difficulty in assembling the camera module and the second control board to the display device.

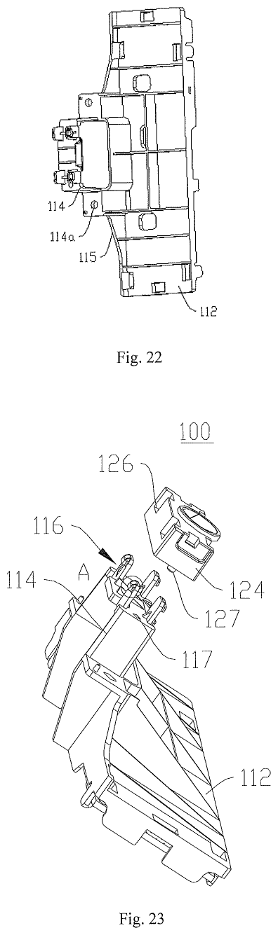

In some embodiments, the camera module mounting assembly 110 further includes a reinforcing plate 115, which is connected to the base 112 and the mounting portion 114, respectively. FIG. 22 illustrates the mounting portion 114, the base 112 and the reinforcing plate 115 in the camera module mounting assembly. The mounting portion 114 may protrude from the plane of the base 112. The cross-sectional area of an end surface of the mounting portion 114 where it is detachably connected to the bracket may be much smaller than the area of a connection surface between the mounting portion 114 and the base 12. The reinforcing plate 115 can enhance the strength of the mounting portion 114 and the base 112 so as to facilitate support of the camera module mounting assembly 110 for the camera and the second control board 130. The outline of the reinforcing plate 115 may present a right-angled triangle. One right-angled side of the reinforcing plate 115 is connected to the base 112, and the other right-angled side is connected to the side wall of the mounting portion 114, thereby improving the overall strength of the base and the mounting portion. The camera module mounting assembly 110 may include a plurality of reinforcing plates 115, and the plurality of reinforcing plates 115 are connected to different portions of the mounting portion 114 respectively. For example, if the cross section of the mounting portion 114 is rectangular, a reinforcing plate 115 may be provided on each side wall of the mounting portion 114. If the cross section of the mounting portion 114 is circular, the plurality of reinforcing plates 115 may be connected to the peripheral wall of the mounting portion 114 at equal intervals. FIG. 22 further illustrates a first connection hole 114a in the mounting portion 114. Correspondingly, a second connection hole (for example, as shown by 229 in FIG. 4) may be provided on the second side wall of the side frame of the display device, and the display device may include a connector for connecting the first connection hole 114a and the second connection hole 229. When assembling the display device, after the camera module mounting assembly is placed in the mounting slot 225 in FIG. 4, the first connection hole 114a is aligned with the second connection hole 229, and the connector is fixed between the first connection hole 114a and the second connection hole 229, so that the camera module mounting assembly and the camera in the bracket 124 of the camera module mounting assembly are fixed to the side frame of the display device. Similarly, the number of first connection holes 114a in the mounting portion 114 and the number of second connection holes 229 on the second side wall of the side frame may be multiple, thereby improving the connection strength between the camera module mounting assembly and the side frame.

The detachable connection between the mounting portion and the bracket in the camera module mounting assembly will be further described below with reference to FIGS. 23 to 25. According to some embodiments of the application, the mounting portion in the camera module mounting assembly includes a first positioning portion, the bracket includes a second positioning portion, and the first positioning portion cooperates with the second positioning portion to connect the mounting portion with the bracket. Further, one of the first positioning portion and the second positioning portion may include a positioning hole, and the other of the first positioning portion and the second positioning portion may include a clamping positioning column, and the clamping positioning column extends into the positioning hole to connect the mounting portion and bracket.

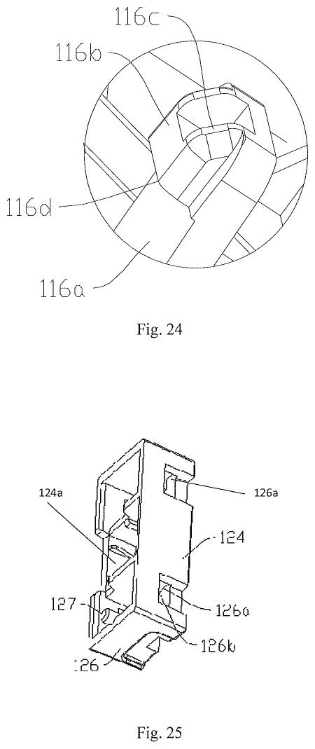

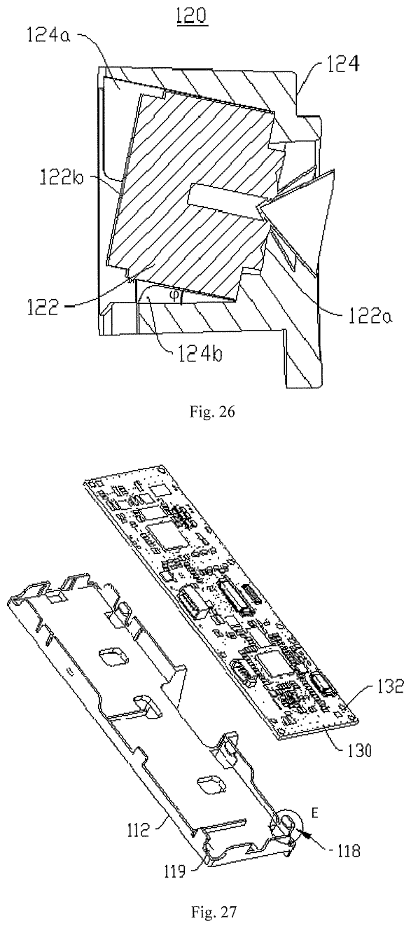

As shown in FIG. 25, the bracket 124 includes a second positioning portion 126, the second positioning portion 126 includes a positioning hole 126a, the mounting portion 114 includes a first positioning portion 116, the first positioning portion 116 includes a clamping positioning column, and the clamping positioning column may extend into the positioning hole 126a to connect the mounting portion 114 and the bracket 124. As shown in FIG. 24 combined with FIG. 25, the clamping positioning column includes a first connection section 116a and a first clamping section 116b that are connected to each other. An end of the first connection section 116a away from the first clamping section 116b is connected to the mounting portion 114, the side wall of the positioning hole 126a is provided with an engagement groove 126b, the first connection section 116a extends into the positioning hole 126a, and the first clamping section 116b is engaged in the engagement groove 126b.

As shown in FIG. 24, in some embodiments, the first clamping section 116b has a first guide surface 116c and a first clamping surface 116d, and the first guide surface 116c is disposed in an inclined manner with respect to the main body of the first clamping section 116b. During the process of connecting the mounting portion to the bracket 124, the clamping positioning column extends into the positioning hole 126a, the first guide surface 116c resists the inner wall of the positioning hole 126a, the bracket 124 slides relative to the first guide surface 116c, the second positioning portion 126 of the bracket will be slightly deformed under the resistance of the positioning hole 126a, and the mounting portion as a whole slides towards the bracket until the first clamping section 116b slides to the engagement groove 126b. The positioning hole 126a is released from the resistance of the first guide surface 116c, and the overall second positioning portion 126, under the effect of its own restoring force, enables the first clamping surface 116d to be clamped to the bottom of the engagement groove 126b, so that the first positioning portion 116 and the second positioning portion 126 are clamped to each other.

In some embodiments, the mounting portion includes a plurality of first positioning portions 116, and the bracket 124 may include a plurality of second positioning portions 126 to enhance positioning and connection between the mounting portion 114 and the bracket 124. The section of the first clamping section 116b may substantially present a right-angled triangle, with one right-angled side connected to the first connection section 116a, and the other right-angled side close to the base 112. A surface where the right-angled side is located is the first clamping surface 116d, and a surface where the hypotenuse of the right-angled triangle is located is the first guide surface 116c.

As shown in FIG. 25, in this embodiment, the bracket 124 includes an accommodating groove 124a. When the bracket 124 is connected to the mounting portion 114, the mounting portion 114 and the accommodating groove 124a form the aforementioned first cavity for accommodating the camera. Moreover, in the example of FIG. 25, the bracket 124 includes two positioning holes 126a, and the two positioning holes 126a are provided on two sides of the accommodating groove respectively, thereby enhancing the connection and fixing effects between the bracket 124 and the mounting portion 114. Correspondingly, the bracket may include two positioning portions 126, and each positioning portion 126 is provided with a positioning hole 126a.

Further, in some embodiments, as shown in FIGS. 23 and 25, the mounting portion 114 further includes a first fixing portion 117, the bracket 124 further includes a second fixing portion 127, and the first fixing portion 117 cooperates with the second fixing portion 127 to limit a displacement of the bracket 124 in a predetermined direction, which is different from a connection direction in which the bracket 124 is connected to the mounting portion 114. The connection direction here refers to a direction in which the bracket 124 or the mounting portion 114 is moved so that the bracket 124 and the mounting portion are aligned until they are connected to each other. One of the first fixing portion 117 and the second fixing portion 127 includes a fixing hole, and the other of the first fixing portion 11 and the second fixing portion 127 includes a fixing column, and the fixing column extends into the fixing hole to limit a displacement of the bracket in a predetermined direction.

During the process of connecting the mounting portion to the bracket, the first positioning portion 116 and the second positioning portion 126 cooperate with each other to connect the mounting portion to the bracket. However, there is a risk that the bracket 124 separates from the mounting portion 114. The first fixing portion 117 and the second fixing portion 127 described above can limit a displacement of the bracket 124 in a direction different from the connection direction in which the bracket 124 is connected to the mounting portion 114, and help to realize more accurate positioning of the bracket 124 and the mounting portion 114, thereby decreasing the risk of the bracket 124 separating from the mounting portion 114, and improving the mounting precision accuracy between the mounting portion and the bracket.

As shown in FIG. 23, the first fixing portion 117 may be a fixing hole provided in the mounting portion 114, and the second fixing portion 127 may be a fixing column provided on the bracket 124. When assembling the bracket and the mounting portion, the second fixing portion 127 extends into the fixing hole, so that the mounting portion 114 and the bracket 124 are aligned and positioned. Alternatively, the first fixing portion 117 may be a fixing column provided on the mounting portion 114, and the second fixing portion 127 may be a fixing hole provided on the bracket 124. Similarly, when assembling the bracket and the mounting portion, the fixing column extends into the fixing hole to achieve alignment and positioning of the mounting portion 114 and the bracket 124. In this embodiment, the length extension direction of the fixing column and the axial direction of the fixing hole are consistent with the connection direction mentioned above. The cooperation between the fixing column and the fixing hole can limit a displacement of the bracket in other directions that are angled with the connection direction, thereby facilitating the alignment and cooperation between the first positioning portion 116 and the second positioning portion 126.

When the mounting portion and the bracket are connected to each other, the camera is accommodated in the first cavity formed by the mounting portion and the bracket. The first cavity includes an accommodating groove for the bracket. FIG. 26 illustrates a sectional view of a bracket in which a camera is arranged. As shown in FIG. 26, the accommodating groove 124a includes a limiting rib 124b. The limiting rib 124b is used to support a side surface of the camera 122 adjacent to the image capturing surface 122a, so that the side surface forms an included angle of 5 to 20 degrees (as shown by the angle o in FIG. 26) with respect to the horizontal direction perpendicular to the first side wall of the side frame of the display device. The first side wall includes a first opening, and the image capturing surface of the camera is exposed via the first opening. The first side wall here is similar to the first side wall 460 described with reference to FIG. 14. When the user employs the display device to acquire the target object in front of the display device, the first side wall is a side wall of the side frame of the display device facing the user or the target object. In this embodiment, the horizontal direction perpendicular to the first side wall of the side frame of the display device is also an extension direction of one side of the bracket. As a result, when the camera module is assembled to the side frame of the display device, the image capturing surface 122a of the camera 122 is not parallel to the plane where the first side wall of the side frame of the display device is located, but tilts at a certain angle towards the user with respect to the plane where the first side wall is located, in this way, the camera can capture images of regions that include more target objects (for example, humans) as much as possible when the user is operating the display device. For example, in the case that the display device is an electronic blackboard, the camera can be installed on an upper portion of the frame of the display device. In this case, the camera 122 is in a downward tilting posture in the bracket, so that it can capture images of objects in front of the display device 200 from top to bottom. For example, in the case that the display device 200 is an electronic blackboard, during the course of a teacher's class, the camera 122 can capture images of the teacher as much as possible, including the teacher's face and body movements of the upper body, thereby improving the experience of online lectures.

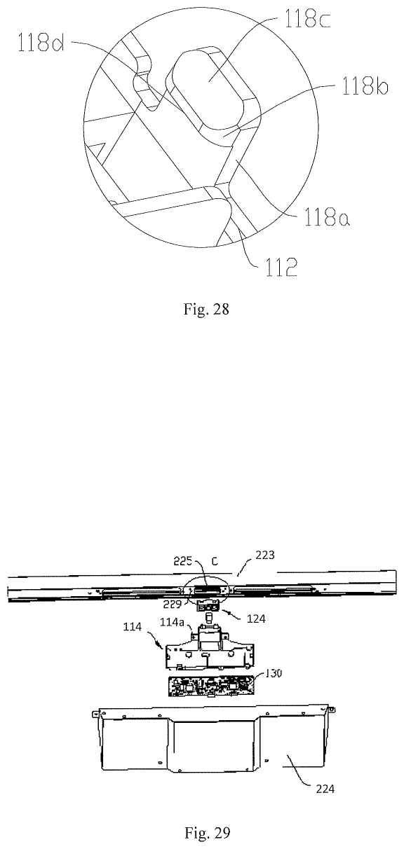

In some embodiments, the base includes a base body and a plurality of clamping members on an edge of the base body, and the plurality of clamping members are used to clamp the second control board to the base. The connection between the base and the second control board will be further described below in conjunction with FIGS. 27 and 28.

As shown in FIGS. 27 and 28, the edge of the base body is provided with a plurality of clamping members 118. The clamping member 118 includes a second connection section 118a and a second clamping section 118b. One end of the second connection section 118a is connected to the base body, and the other end of the second connection section 118a is connected to the second clamping section 118b. The second clamping section 118b is arranged opposite to the base body, and the second control board 130 is arranged between the base body and the second clamping section 118b.

As shown in FIG. 28, the second clamping section 118b has a second guide surface 118c and a second clamping surface 118d. The second guide surface 118c is disposed in an inclined manner with respect to the main body of the second clamping section 118b. During the process of connecting the second control board 130 to the base 112, the second control board 130 first resists the second guide surface 118c and causes it to slide relative to the second guide surface 118c. The overall clamping member 118 will be slightly deformed under the resistance of the second control board 130, so that the entire second control board 130 continues to slide towards the base, until the second control board 130 stops resisting the second guide surface 118c. The overall clamping member 118, under the effect of its own restoring force, enables the second control board 130 to be clamped between the base 112 and the second clamping section 118b, thereby limiting the position of the second control board 130.

In some embodiments, the base may include a plurality of clamping members 118, and the plurality of clamping members 118 may be disposed along the periphery of the base 112 so as to clamp the second control board 130 on the base 112 from positions around the second control board 130. During the process of assembling or connecting the second control board 130 to the base 112, the second control board 130 first resists the second guide surfaces 118c of the plurality of clamping members 118, causing the plurality of clamping members 118 to deform outwardly. The second control board 130 can move towards the base. After the second control board 130 stops resisting the plurality of second guide surfaces 118c, the plurality of clamping members 118 rebound inwards under the effect of their own restoring force, so that the second control board 130 is fixed between the second clamping surface 118d and the base 112, and the second clamping surface 118d can limit the position of the second control board 130.

In the example of FIG. 27, the base 112 further includes a first limiting portion 119, and the second control board 130 includes a second limiting portion 132. The first limiting portion 119 and the second limiting portion 132 may be fixedly connected using a fixing member, thereby enhancing the reliability of connection between the base and the second control board. The first limiting portion 119 includes a first limiting hole provided on the main body of the base 112, the second limiting portion 132 includes a second limiting hole provided on the main body of the second control board 130, and the fixing member may be provided in the first limiting hole and the second limiting hole to fix the control board 130 on the base 112. Similarly, the number of first limiting holes on the base and the number of second limiting holes on the second control board may be multiple. The plurality of first limiting holes are arranged along the periphery of the base 112, and the plurality of second limiting holes are arranged along the periphery of the control board 130.

In this embodiment, the bracket, the camera, and the second control board may all be connected to the base and the mounting portion. The base and the mounting portion may be connected to each other or integrally formed, so as to enable the second control board and the camera module to be formed into one piece, so that the camera module and the second control board can be assembled to the side frame of the display device at one time, which reduces the component mounting steps and mounting workload of the display device, and also decreases the difficulty in assembling the camera module and the second control board to the display device.

FIG. 29 illustrates an exploded view of partial components in a display device according to an embodiment of the application. As shown in FIG. 29, in this embodiment, the display device comprises a display module (not shown), a side frame (a second side wall 223 of the side frame is shown in FIG. 29), the mounting portion, the base connected to the mounting portion, the bracket 124 and the second control board 130 described in the foregoing embodiments. In FIG. 29, the mounting portion, the base, the bracket and second control board are enlarged. The second side wall 223 of the side frame includes a second opening, and the first side wall includes a first opening, thereby forming a mounting slot 225. The first opening in the first side wall may also be regarded as an image capturing hole of the camera. The camera module and the second control board mentioned above can be accommodated in the mounting slot 225, and the image capturing surface of the camera in the camera module is exposed via the image capturing hole, so that the camera can capture images through the image capturing hole. FIG. 4 can be understood as a partial enlarged view of the portion indicated with “C” in FIG. 29.

In this embodiment, the mounting portion 114 includes a first connection hole 114a, and the second side wall of the side frame includes a second connection hole 229. The display device may further comprise a fixing member for fixedly connecting the first connection hole 114a and the second connection hole 229. In this embodiment, the display device further comprises a mounting shell 224 within which the camera module and the second control board 130 are disposed. The mounting shell 224 may be fixed to the second side wall 223 of the side frame of the display device. Referring back to FIG. 3, FIG. 3 illustrates a state when the mounting shell 224 is fixed to the second side wall 223 of the side frame. The camera, the camera module mounting assembly and the second control board may all be arranged within the mounting shell 224. The mounting shell 224 can play the role of protecting the camera, the camera module mounting assembly and the second control board, and can also improve the aesthetics of the display device.

In the embodiment of FIG. 3, the display device further comprises a reinforcing member 226, which may be connected to the second side wall 223 to enhance the mechanical strength of the side frame. Alternatively, the reinforcing member 226 may be disposed on the module backplane for supporting the display module of the display device. The module backplane is fixed to the side frame, and the reinforcing member 226 may enhance the overall mechanical strength of the module backplane and the side frame. The shape of the reinforcing member 226 may be designed according to the surface area and shape of the module backplane. The reinforcing member 226 may be in a grid shape, and multiple reinforcing members 226 may also be arranged in a staggered manner on the module backplane.

When the camera module 100 is being assembled, it is possible to firstly assemble a camera component 120 to the mounting assembly 110, and then assemble the control board 130 to the bracket 124, or firstly assemble the control board 130 to the mounting assembly 110 and then assemble the camera component 120 to the mounting assembly 110, or assemble the camera component 120 and the control board 130 to two ends of the mounting assembly 110 simultaneously.

In the description of this specification, descriptions with reference to the terms “an embodiment,” “some embodiments” “an example” “specific examples”, “some examples”, and the like mean that specific features, structures, materials or characteristics described in conjunction with the embodiment(s) or example(s) are included in at least one embodiment or example of the present application. In this specification, schematic expressions of the above terms are not necessarily directed to the same embodiment or example. Furthermore, the specific features, structures, materials or characteristics described may be combined in any suitable manner in any one or more embodiments or examples. In addition, those skilled in the art may unite and combine different embodiments or examples described in this specification.

1. A display device, comprising:
a frame for carrying an internal module of the display device; and
a camera module comprising a camera and a camera module mounting assembly,
wherein the internal module comprises the camera module, the camera module mounting assembly comprises a bracket and a mounting portion, the mounting portion is configured to be detachably connected to the bracket, the bracket and the mounting portion form a first cavity for accommodating the camera when the bracket is connected to the mounting portion, and
wherein the mounting portion is connected to the frame to assemble the bracket and the camera to the frame.

2. (canceled)

3. The display device according to claim 1, wherein the frame comprises a side frame extending along at least a portion of a periphery of the display device,
wherein the side frame comprises a first side wall, a second side wall and a third side wall, the first side wall and the second side wall face each other, and the third side wall connects the first side wall and the second side wall respectively to form a second cavity,
wherein the first side wall comprises a first opening, the second side wall comprises a second opening, and the camera module mounting assembly passes through the second cavity via the second opening and extends to the first opening, so that an image capturing surface of the camera in the first cavity is exposed via the first opening, and
wherein the mounting portion is connected to the second side wall of the side frame.

4. The display device according to claim 1, wherein the mounting portion comprises a first positioning portion, the bracket comprises a second positioning portion, and the first positioning portion cooperates with the second positioning portion to connect the mounting portion and the bracket.

5. The display device according to claim 4, wherein the bracket further comprises a bracket body connected to the second positioning portion, the bracket body comprises a bracket through hole penetrating the bracket body, and an image capturing surface of the camera is exposed via the bracket through hole.

6. The display device according to claim 5, wherein one of the first positioning portion and the second positioning portion comprises a buckle, another of the first positioning portion and the second positioning portion comprises a protrusion matching the buckle, and the buckle mates with the protrusion to connect the mounting portion and the bracket.

7. The display device according to claim 6, wherein the second positioning portion comprises a bracket connector extending and protruding from an edge of the bracket body in a direction perpendicular to a plane of the bracket body, the bracket body, the bracket connector and the first positioning portion of the mounting portion form the first cavity when the bracket is connected to the mounting portion via the bracket connector.

8. The display device according to claim 7, wherein the camera comprises a back surface facing the image capturing surface and a side surface adjacent to the back surface, wherein the first positioning portion comprises a first support surface for supporting the back surface and a second support surface for supporting a portion of the side surface.

9. The display device according to claim 8, wherein the bracket connector of the second positioning portion comprises the buckle, the first positioning portion comprises a first positioning portion body and the protrusion, and the first positioning portion body comprises the first support surface and the second support surface, and
wherein the protrusion extends and protrudes from a surface of the first positioning portion body facing the second support surface in a direction facing away from the second support surface.

10. The display device according to claim 8, wherein the mounting portion further comprises a mounting portion body connected to the first positioning portion, an extension direction of the mounting portion body is consistent with a width direction of a third side wall pointing from a second side wall to a first side wall, and the first support surface forms an included angle of 105 to 115 degrees with respect to the extension direction of the mounting portion body.

11. The display device according to claim 3, wherein the display device further comprises a microphone array module and a microphone array mounting assembly for assembling the microphone array module to the side frame, wherein the microphone array mounting assembly is connected to the second side wall, and the microphone array module is disposed between the microphone array mounting assembly and the first side wall.

12. The display device according to claim 11, wherein the microphone array module comprises at least one microphone array strip, and the microphone array mounting assembly comprises at least one adapter for connecting respective one of the at least one microphone array strip to the side frame, and
wherein the adapter comprises at least one presser and at least one hanger, the hanger is connected to a surface of the second side wall facing away from the first side wall, and the presser is connected to a surface of the microphone array strip facing away from the first side wall.

13. The display device according to claim 12, wherein the adapter comprises an adapter body, and the at least one presser extends and protrudes from a first edge of the adapter body along a first direction intersecting a plane where the adapter body is located, wherein at least some of the at least one presser comprises a presser body and a presser positioning column, and the presser positioning column extends and protrudes from the presser body in a second direction parallel to the plane where the adapter body is located, and
wherein the microphone array strip comprises at least one via hole, and the presser positioning column passes through a corresponding via hole of the at least one via hole to position the at least one microphone array strip to the at least one adapter.

14. The display device according to claim 13, wherein the display device further comprises a first control board electrically connected to the microphone array module and a support member for supporting the first control board, and the adapter further comprises a bridge structure extending and protruding from the adapter body along a third direction opposite to the first direction, and
wherein the support member is connected to the bridge structure of the adapter so as to fix the first control board to the side frame via the support member and the adapter.

15. The display device according to claim 14, wherein the at least one microphone array strip comprises a first microphone array strip and a second microphone array strip, a length extension direction of each of the first microphone array strip and the second microphone array strip is consistent with a length extension direction of the first side wall of the side frame, and the first microphone array strip and the second microphone array strip are located on two sides of the camera module respectively in the length extension direction of the first side wall.

16. The display device according to claim 15, wherein each microphone array strip of the first microphone array strip and the second microphone array strip comprises a plurality of microphones and a plurality of sound receiving holes corresponding to the plurality of microphones, the plurality of sound receiving holes are arranged along a length direction of the microphone array strip, and a distance between any two adjacent sound receiving holes in the first microphone array strip or the second microphone array strip along the length extension direction of the first side wall is equal to a distance between two sound receiving holes of the first microphone array strip and the second microphone array strip which are closest to each other along the length extension direction.

17. The display device according to claim 15, wherein the at least one adapter comprises a first adapter and a second adapter for connecting the first microphone array strip and the second microphone array strip to the side frame, respectively, and each hanger in the first adapter and the second adapter extends and protrudes from a second edge of the adapter body facing the first edge along the first direction.

18. The display device according to claim 16, wherein the first side wall of the side frame comprises a plurality of grooves in one-to-one correspondence with the plurality of sound receiving holes, each of the grooves is used to accommodate an acoustic foam, the first side wall further comprises a plurality of side wall through holes in one-to-one correspondence with the plurality of grooves, and each side wall through hole extends from a bottom surface of the groove close to an outer surface of the first side wall to the outer surface of the first side wall.

19. The display device according to claim 17, wherein the bridge structure extends and protrudes from the second edge of the adapter body along a third direction opposite to the first direction, and
wherein the support member is connected to bridge structures of the first adapter and the second adapter, respectively, so as to fix the first control board to the side frame via the support member, the first adapter and the second adapter.

20. The display device according to claim 14, wherein the display device further comprises a display module and a module backplane for supporting the display module, the support member comprises a support body and a lateral rib, and the lateral rib extends and protrudes from at least a part of an edge of the support body along a fourth direction intersecting a plane of the support body to abut on a surface of the module backplane facing away from the display module.

21. The display device according to claim 20, wherein the display device comprises a mainboard for controlling the display device, the camera is electrically connected to the first control board via a camera connection line, and the first control board is electrically connected to the mainboard via a control board connection line, and
wherein the support body comprises a first notch on a first side of the support body and a second notch on a second side of the support body, the first side and the second side face each other, and the module backplane comprises a backplane opening corresponding to the second notch, wherein the first notch is configured to allow the camera connection line to pass through, and the second notch and the backplane opening are configured to allow the control board connection line to pass through.

22.-31. (canceled)
